(19) United States
(12) Patent Application Publication
(10) Pub. No.: US 2005/0214571 A1
(43) Pub. Date: Sep. 29, 2005

(54) Organic EL element

(75) Inventor: Hiroshi Kishimoto, Tokyo (JP)

Correspondence Address: SEYFARTH SHAW, 55 EAST MONROE STREET, SUITE 4200, CHICAGO, IL, 60603-5803, US

(73) Assignee: Dai Nippon Printing Co., Ltd.

(21) Appl. No.: 11/082,471

(22) Filed: Mar. 17, 2005

(30) Foreign Application Priority Data
Mar. 23, 2004 (JP) 2004-085336

(51) Int. Cl. H05B 33/12

(52) U.S. Cl. 428/690; 428/917; 313/504; 313/506

(57) ABSTRACT

An object of the present invention is to improve the light emitting efficiency, so as to improve the lifetime of the light emitting substance itself, by optimizing the material composition of the layers which influence light emitting conditions of an organic EL element, particularly a hole transporting layer. An excellent organic EL element in terms of the light emitting efficiency and the lifetime can be obtained by making the organic EL element having a laminated structure of at least: a first electrode; a hole transporting layer; a light emitting layer; and a second electrode laminated in sequence, wherein a composition ratio of the hole transporting layer is: poly(ethylene dioxythiophene)/the polystyrene sulfonic acid=1/20 to 1/6, and the hole transporting layer is composed of a mixture whose composition ratio is selected so that the light emitting efficiency will be the maximum.

### BACKGROUND OF THE INVENTION

1. Field of the Invention

The present invention relates to an organic electroluminescent (EL) element which emits light by applying an electric voltage.

2. Background of the Invention

An organic EL element, which is a kind of a display element, have the advantages such as the thinness, a high brightness by a low voltage drive, and requires a small number of layers to be formed, so that it is expected to be the element to take place of a liquid crystal display element. A representative organic EL element comprises a laminated structure of at least a first electrode, a hole transporting layer, a light emitting layer and a second electrode laminated in sequence, or a laminated structure further comprising an electron transporting layer, that is, a first electrode, a hole transporting layer, a light emitting layer, an electron transporting layer and a second electrode laminated in sequence. In addition to these layers, several layers may be provided additionally.

The organic EL elements include, on the whole, those of a high molecular type using a high molecular type light emitting substance and those of a low molecular type using a low molecular type light emitting substance. In the former, the organic EL layer is formed by a coating method with the high molecular type light emitting substance dissolved in an organic solvent, and in the latter, the organic EL element is formed by the vacuum film forming method, such as vacuum deposition method or the like, with the low molecular type light emitting substance.

The lifetime of the organic EL element largely depends on the lifetime of the light emitting substance. In the present situation, the high molecular type organic EL element tends to have a relatively shorter element lifetime compared with the low molecular type organic EL element. Moreover, as to the low molecular type organic EL element, the brightness at the time of driving the organic EL element with a low current is drastically reduced with time passage. Thus, it can hardly be adopted for a product to be used for a long time such as a display for TV set or the like. Furthermore, since the brightness is drastically lowered with time passage at the initial stage of the use, it can easily lead to defects such as seizing of the display or the like, and restraint of such decline of the brightness with time passage is strongly called for.

For example, it is said that the lifetime of the electroluminescence assembly can be prolonged by forming an intermediate layer, in between a lower electrode and a light emitting layer, by using a solution obtained by dissolving or dispersing a polymeric organic conductive material having a 1 μm or less diameter (Japanese Patent Application Laid-Open (JP-A) No. 2000-91081).

Moreover, it is also said that since the volume resistance ratio will be 3×10¹⁰ Ωcm or more by refining a light emitting organic compound so as to have the ionic impurity concentration of 0.01 ppm or less, the current other than the current derived from re-coupling of the carrier can be restrained so that deterioration by the heat generation can be restrained (JP-A No. 2001-214159).

According to the invention described in JP-A No. 2000-91081, it is said that the instability with time passage can be solved because generation of the short circuit between the electrodes can be reduced extremely. However, there is no description concerning the lifetime of the light emitting substance. Moreover, as to the invention described in JP-A No. 2001-214159, it is not to improve the essential lifetime of the light emitting substance.

### SUMMARY OF THE INVENTION

An object of the present invention is to improve the light emitting efficiency by optimizing the material composition of the layers which influence the conditions for the light emitting substance, particularly the hole transporting layer, so as to improve the lifetime of the light emitting substance itself.

It has been learned that the object can be solved by defining the composition ratio of the poly (ethylene dioxythiophene) and the polystyrene sulfonic acid in a hole transporting layer which comprises the representative components of a poly(ethylene dioxythiophene) and a polystyrene sulfonic acid so that the present invention is achieved.

A first aspect of the invention relates to an organic EL element having a laminated structure of at least: a first electrode; a hole transporting layer; a light emitting layer; and a second electrode laminated in sequence, wherein the hole transporting layer comprises components of: a poly(ethylene dioxythiophene); and a polystyrene sulfonic acid, a composition ratio of the components is: poly(ethylene dioxythiophene)/the polystyrene sulfonic acid=1/20 to 1/6, and the composition ratio of the components corresponds to a light emitting efficiency maximum value ηm in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

A second aspect of the invention relates to an organic EL element having a laminated structure of at least: a first electrode; a hole transporting layer; a light emitting layer; and a second electrode laminated in sequence, wherein the hole transporting layer comprises components of: a poly(ethylene dioxythiophene); and a polystyrene sulfonic acid, a composition ratio of the components is: poly(ethylene dioxythiophene)/the polystyrene sulfonic acid=1/20 to 1/6, and the composition ratio of the components corresponds to 0.7 ηm to ηm, when ηm is a light emitting efficiency maximum value in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

A third aspect of the invention relates to an organic EL element having a laminated structure of at least: a first electrode; a hole transporting layer; a light emitting layer; a electron transporting layer; and a second electrode laminated in sequence, wherein the hole transporting layer comprises components of: a poly(ethylene dioxythiophene); and a polystyrene sulfonic acid, a composition ratio of the components is: poly(ethylene dioxythiophene)/the polystyrene sulfonic acid=1/20 to 1/6, and the composition ratio of the components corresponds to 0.7 ηm to ηm, when ηm is a light emitting efficiency maximum value in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

A fourth aspect of the invention relates to the organic EL element according to any one of the first to third aspects, wherein the organic EL element comprises two or more kinds of the laminated structures whose light emitting layers comprise different light emitting materials.

A fifth aspect of the invention relates to the organic EL element, wherein the light emitting material forming the light emitting layer, of each laminated structure of the organic EL element according to the fourth aspect, is different from each other, and the composition ratios of the components forming the hole transporting layer in each of at least two laminated structures “a” and “b”, among the laminated structures, are a common composition ratio corresponding to an overlapped portion of both ranges of 0.7 ηma to ηma and 0.7 ηmb to ηmb, when ηma is the light emitting efficiency maximum value in a light emitting efficiency local maximum value θa-composition ratio curve, and ηmb is the light emitting efficiency maximum value in a light emitting efficiency local maximum value θb-composition ratio curve, which are obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

A sixth aspect of the invention relates to the organic EL element, wherein the light emitting material forming the light emitting layer, of each laminated structure of the organic EL element according to the fourth aspect, is different from each other, and the composition ratios of the components forming the hole transporting layer in each of at least two laminated structures “a” and “b”, among the laminated structures, are a common composition ratio corresponding to light emitting efficiency maximum value ηm (a×b) in a×b-composition ratio curve, which is obtained by changing the composition ratio of each light emitting efficiency local maximum value ηa and ηb (ηa and ηb are light emitting efficiency local maximum values in each light emitting efficiency-voltage curve, which is obtained by changing the applied voltage between the first electrode and the second electrode in each laminated structure).

A seventh aspect of the invention relates to the organic EL element, wherein the light emitting material forming the light emitting layer, of each laminated structure of the organic EL element according to the fourth aspect, is different from each other, and the composition ratios of the components forming the hole transporting layer in each of at least two laminated structures “a” and “b”, among the laminated structures, are composition ratios corresponding to 0.7 ηm (a×b) to ηm (a×b), when rim (a×b) is a light emitting efficiency maximum value in θa×θb-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

According to the first aspect of the invention, an organic EL element having excellent light emitting efficiency and long lifetime can be provided because: the composition ratio of the components forming the hole transporting layer is poly (ethylene dioxythiophene)/polystyrene sulfonic acid=1/20 to 1/6; and the composition ration corresponds to the maximum value rim of the light emitting efficiency local maximum value in a light emitting efficiency local maximum value-composition ratio curve, which is obtained by changing the composition ratio of the light emitting efficiency local maximum value in a light emitting efficiency-voltage curve of each organic EL element produced by the above-mentioned composition ratio.

According to the second or third aspect of the invention, an organic EL element having excellent light emitting efficiency and long lifetime can be provided because: the composition ratio of the components forming the hole transporting layer is poly(ethylene dioxythiophene) /polystyrene sulfonic acid=1/20 to 1/6; and the composition ration corresponds to 0.7 ηm to ηm, when ηm is the maximum value of the light emitting efficiency local maximum value in a light emitting efficiency local maximum value-composition ratio curve, which is obtained by changing the composition ratio of the light emitting efficiency local maximum value in a light emitting efficiency-voltage curve of each organic EL element produced by the above-mentioned composition ratio.

According to the fourth aspect of the invention, in addition to the effects of the first to third aspects of the present invention, an organic EL element having two or more kinds of the laminated structures with different materials forming the light emitting layer can be provided.

According to the fifth aspect of the invention, the composition ratios of the components forming the hole transporting layers, in at least two laminated structures in the fourth aspect of the invention, are a common composition ratio corresponding to an overlapped part of both ranges of 0.7 ηma to ηma and 0.7 ηmb to ηmb (ηma and ηmb are light emitting efficiency maximum values in each laminated structures). Therefore, the composition ratio of the components forming the hole transporting layer in different laminated structure can be made common so that an organic EL element having without drastic deterioration from each light emitting efficiency maximum value can be provided.

According to the sixth aspect of the invention, the composition ratios of the components forming the hole transporting layers in at least two laminated structures in the fourth aspect of the invention are a common composition ratio corresponding to the light emitting efficiency maximum value ηm (a×b) in the θa×θb-composition ratio curve obtained by changing the composition ratio of the light emitting efficiency local maximum values θa and θb in the light emitting efficiency-voltage curve obtained for each structure. Therefore, the composition ratio of the components forming the hole transporting layers in different laminated structures can be made common, and an organic EL element whose geometric mean of the light emitting efficiency in each laminated structure are maximum can be provided.

According to the seventh aspect of the invention, the composition ratios of the components forming the hole transporting layers in at least two laminated structures in the fourth aspect of the invention are a composition ratio corresponding to 0.7 ηm (a×b) to ηm (a×b), when ηm (a×b) is a light emitting efficiency maximum value in the θa×θb-composition ratio curve obtained by changing the composition ratio of the light emitting efficiency local maximum values θa and θb in the light emitting efficiency-voltage curve obtained for each laminated structure. Therefore, an organic EL element without drastic decline from the geometric mean of the light emitting efficiency in each laminated structure can be provided.

### BRIEF DESCRIPTION OF THE DRAWINGS

FIGS. 1A and 1B are diagrams for explaining the laminated structure of an organic EL element.

FIG. 2 shows a current-voltage curve of an organic EL element of the example.

FIG. 3 shows a brightness-voltage curve of the organic EL element of the example.

FIG. 4 shows a light emitting efficiency-voltage curve of the organic EL element of the example.

FIG. 5 shows a light emitting efficiency local maximum value-PEDOT (%) curve of the organic EL element of the example.

### DESCRIPTION OF THE PREFERRED EMBODIMENTS

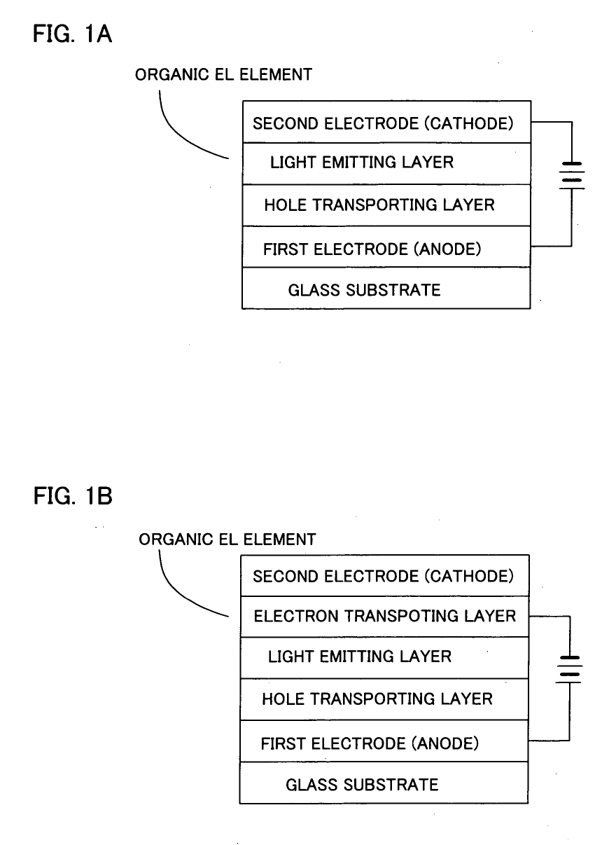

As it is shown representatively in FIG. 1A, an organic EL element of the present invention has a laminated structure comprising: a glass substrate; a first electrode (anode); a hole transporting layer; a light emitting layer; and a second electrode (cathode) laminated from the bottom in the above-mentioned sequence. Alternatively as it is shown in FIG. 1B, it has a laminated structure comprising: a glass substrate; a first electrode (anode); a hole transporting layer; a light emitting layer; an electron transporting layer; and a second electrode (cathode) laminated from the bottom in the above-mentioned sequence. The organic EL element shown in FIG. 1A and the organic EL element shown in FIG. 1B are different in that whether the organic EL element comprises the electron transporting layer, or not. In the organic EL element in the present invention, various layers described later can be added in addition to the basic laminated structure, and the laminated structure itself is same as those in the prior art.

Various materials are comprised in the hole transporting layer. As a representative example thereof, a mixture of a poly(ethylene dioxythiophene) and a polystyrene sulfonic acid can be presented. In the mixture of the two kinds of the compounds, each component is abbreviated as PEDOT for the former and PSS for the latter, that is, acronyms of English expression. Furthermore, the mixture is abbreviated as PEDOT/PSS. The PEDOT/PSS as a mixture is commercially available as, for example, “Baytron” (registered trademark) of Bayer AG, Germany or a product of other manufacturers.

Concerning the hole transporting layer comprising the PEDOT/PSS, the conductivity is improved if the composition ratio of the PEDOT is increased. Therefore, when it is used as the hole transporting layer of the organic EL element, the electric current flow is facilitated as the composition ratio of PEDOT is higher. Also, the brightness, when the organic EL element emits light, is improved.

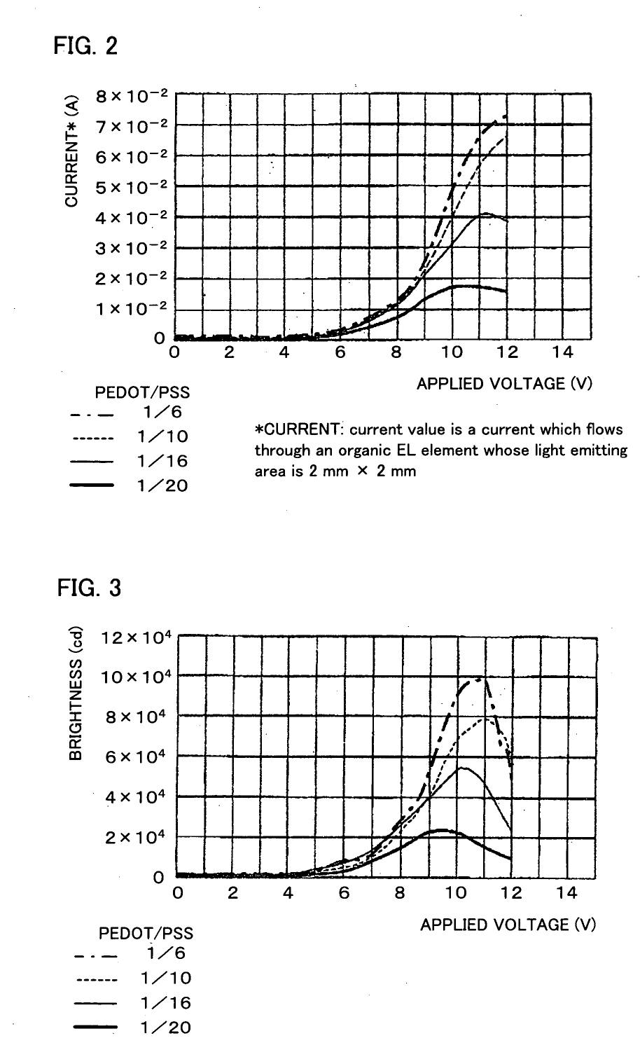

For example, a current (I)-voltage (V) curve as shown in FIG. 2 is obtained by manufacturing the organic EL elements so that the PEDOT/PSS composition ratios (constitution ratio, based on the mass) are 1/20, 1/16, 1/10 and 1/6, and by changing the voltage applied between the first electrode and the second electrode. The organic EL elements used were manufactured by a method explained in the below-mentioned example. As shown in FIG. 2, the current-voltage curve related to each PEDOT/PSS composition ratio shows the tendency that, as the voltage increases, the current is increased so as to increase the conductivity. Thereafter, those of 1/20 and 1/16 composition ratios show a local maximum value. After showing the local maximum values, they were gradually reduced. Although those of 1/10 and 1/6 did not show the local maximum value in the measured range, it is assumed that they show the same tendency as those mentioned above, so that they also show a local maximum value. Moreover, as to each PEDOT/PSS composition ratio, with the increase of the PEDOT composition ratio from 1/20 to 1/16, 1/10 and 1/6, it was confirmed that the current value with respect to the same applied voltage increases in sequence.

Moreover, for the same organic EL elements mentioned above, a brightness-voltage curve was obtained in the same manner as in the case of the current-voltage curve. As shown in FIG. 3, with the increase of the PEDOT composition ratio from 1/20 to 1/16, 1/10 and 1/6, it was confirmed that the brightness with respect to the same applied voltage increases. Moreover, the brightness-voltage curve related to each PEDOT/PSS composition ratio shows a local maximum value, and after showing the local maximum values, they were gradually reduced. From only the results of the current-voltage curve and the brightness-voltage curve mentioned above, higher PEDOT composition ratio facilitates the current flow and it is preferable to apply a voltage corresponding to the local maximum value of the brightness in the brightness-voltage curve in terms of obtaining a high brightness.

However, concerning the organic EL elements whose PEDOT/PSS composition ratio of the hole transporting layers are the same, when their local maximum value of the current-voltage curve and local maximum value of the brightness-voltage curve are compared, the voltages showing the local maximum values in the both curves do not coincide with each other. Therefore, it is conceived that, when the current flow is facilitated, a part of the current is consumed for other purposes, not contributing to the improvement of the brightness.

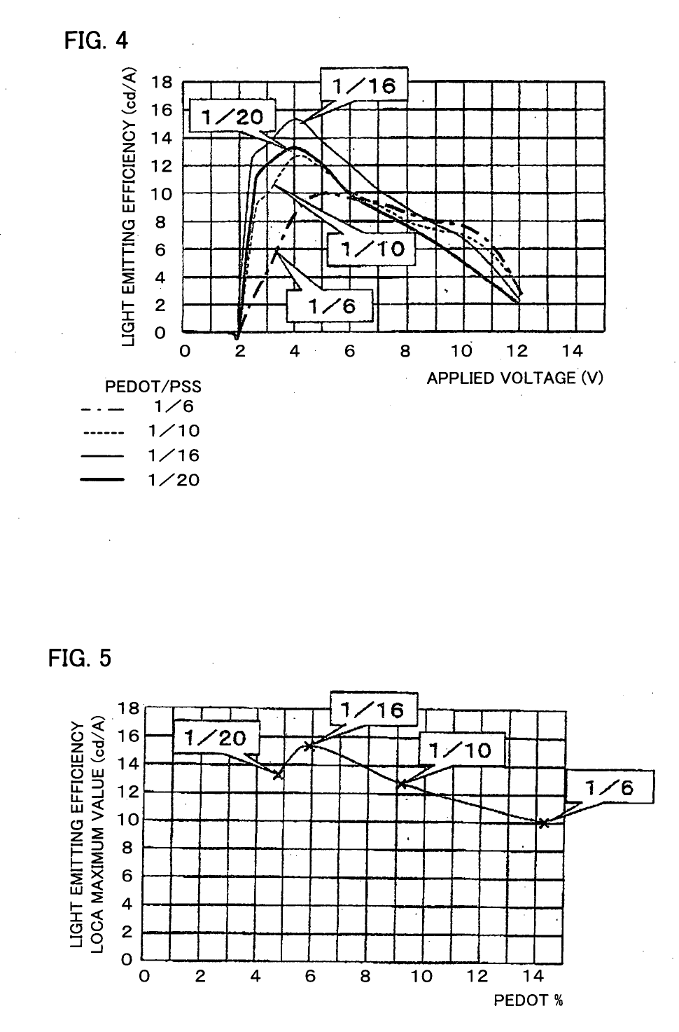

Therefore, from the obtained results, the relationship between the light emitting efficiency (light emitting efficiency =brightness per unit area (cd-m⁻²) /current per unit area (A.m⁻²), therefore the unit is cd/A.) and the voltage was found. As shown in FIG. 4, it was confirmed that: the light emitting efficiency-voltage curve shows a raise for once, as the voltage rises; then, the curve shows the local maximum value in the vicinity of the applied voltage of 4V to 5V; thereafter, the curve shows a decrease. Moreover, as to the composition ratio of the PEDOT/PSS, it was different from the case of the current-voltage curve and the brightness-voltage curve. For example, the following facts were confirmed. In the vicinity of the applied voltage of 3V to 5V, if the PEDOT composition ratio is increased from 1/20 to 1/6, the light emitting efficiency is higher in the case of 1/16 than the case of the 1/20 composition ratio. However, for the 1/16 composition ratio and higher, the light emitting efficiency is lower in the case of 1/10 than the case of 1/16. Furthermore, the light emitting efficiency is lower in the case of 1/6 than the case of 1/10. The relationship between the composition ratio and the light emitting efficiency local maximum value at the composition ratio, in the light emitting efficiency-voltage curve per each composition ratio in FIG. 4, is shown in FIG. 5. It is clear that the light emitting efficiency has the maximum value in the vicinity of the 1/16 composition ratio by linking the four points by a curve.

Based on these results, in order to improve the light emitting efficiency of the organic EL element, as compared to selecting the PEDOT/PSS composition ratio by referring only to the local maximum value of the current-voltage curve and the local maximum value of the brightness-voltage curve, it is preferable to further obtain the light emitting efficiency-voltage curve and to select the composition ratio from the relationship between the composition ratio and the light emitting efficiency local maximum value per each composition ratio, based on the light emitting efficiency-voltage curve.

For example, with premises that: θ is a light emitting efficiency local maximum value in a light emitting efficiency-voltage curve; and ηm is a maximum value of the light emitting efficiency local maximum value in a light emitting efficiency local maximum value θ-composition ratio curve, which is obtained by changing the PEDOT/PSS composition ratio of the local maximum value θ, the light efficiency of the organic EL element can be made excellent and the lifetime of the organic EL element can be made longer by setting the composition ratio of PEDOT/PSS to be the composition ratio corresponding to ηm.

Moreover, when setting the composition ratio not to the composition ratio corresponding to ηm, with the premise that the maximum value of the light emitting efficiency local maximum values in the light emitting efficiency local maximum value θ-composition ratio curve is ηm, it is preferable that the composition ratio is a composition ratio corresponding to 0.7 ηm or more. By setting the composition ratio corresponding to 0.7 nm or more, the light emitting efficiency of the organic EL element can be made excellent. And furthermore, the lifetime of the organic EL element can be made longer, even if the composition ratio is not set to the composition ratio corresponding to rim. Here, 0.8 ηm is more preferable than 0.7 ηm, and further preferably 0.9 ηm. In general, in the case of a static display, the brightness of the organic EL element is not necessarily made higher. The composition ratio corresponding to ηm or the composition ratio corresponding to ηm to 0.7 ηm as mentioned in the above does not depend on the presence of the electron transporting layer mentioned above.

In the case of the PEDOT/PSS composition ratio set as mentioned above, since the current not contributing to the light emission in the organic EL element can be reduced, it is considered that deterioration in the hole transporting layer or the light emitting layer, by the current not contributing to the light emission, can be restrained.

In the above description, an organic EL element having only one kind of the light emitting layer has been explained. However, when providing an organic EL element of a full color display, there is a method of using three kinds of light emitting layers for emitting light of the tree primary colors of light, a red color, a green color and a blue color placed next to each other. Alternately, there is a two-color emitting type organic EL element, wherein two kinds of the light emitting layers are placed next to each other. In these cases, since the light emitting materials in each light emitting layer are different, the energy necessary for the light emission differs in general. Therefore, the relationship between the light emitting efficiency and the applied voltage differs as well. Moreover, in order to improve the light emitting efficiency of each light emitting material, it is preferable that the PEDOT/PSS composition ratio in the hole transporting layer differs.

Accordingly, in the case of using a plurality of kinds of light emitting layers, whose light emitting materials to be used are different with each other, are placed next to each other in one organic EL element, as in the case of providing an organic EL element of a full color display or a two color display, it is ideal that the preferable PEDOT/PSS composition ratio range as mentioned above and the applied voltage range are determined for each light emitting material.

However, in reality, in the case of using a plurality of kinds of light emitting layers in one organic EL element next to each other, it is not only troublesome to determine the PEDOT/PSS composition ratio range for each light emitting material but also the hole transporting layer must be formed in a pattern for each kind of the light emitting layer so that it is extremely troublesome also in terms of the production. Therefore, concerning two or more kinds of the light emitting layers, in reality, for two kinds or three kinds of the light emitting layers, it is preferable to use the same PEDOT/PSS composition ratio.

Therefore, in the case one organic EL element has two or more laminated structures of different light emitting materials forming the light emitting layer, for a laminated structure A and another laminated structure B of a different light emitting material, it is preferable to determine the PEDOT/PSS composition ratio as follows.

First, for the laminated structure A, with the premise that the light emitting efficiency local maximum value in the light emitting efficiency-voltage curve is θa, the maximum value ηma of the light emitting efficiency local maximum values in the light emitting efficiency local maximum value θa-composition ratio curve, obtained by changing the PEDOT/PSS composition ratio of local maximum value θa, is obtained. Then, for the laminated structure B, with the premise that the light emitting efficiency local maximum value in the light emitting efficiency-voltage curve is θb, the maximum value ηmb of the light emitting efficiency local maximum values in the light emitting efficiency local maximum value θb-composition ratio curve, obtained by changing the PEDOT/PSS composition ratio of local maximum value θb, is obtained. It is preferable that the PEDOT/PSS composition ratios in the laminated structure A and the laminated structure B are a common composition ratio corresponding to an overlapped portion of the range of 0.7 ηma to ηma and the range of 0.7 ηmb to ηmb. Accordingly, in one organic EL element, the composition ratios of the components forming the hole transporting layers in different laminated structures can be set in common. Therefore, an organic EL element without drastic deterioration from each light emitting efficiency maximum value can be provided. The coefficient 0.7 to be multiplied to ηma or ηmb is more preferably 0.8, and further preferably 0.9.

In the case one organic EL element has two or more laminated structures of different light emitting materials forming the light emitting layer, for a laminated structure A and another laminated structure B of a different light emitting material, the PEDOT/PSS composition ratio can also determined as follows. First, for the laminated structure A, with the premise that the light emitting efficiency local maximum value of the light emitting efficiency-voltage curve is θa, the light emitting efficiency local maximum value θa-composition ratio curve is obtained by changing the PEDOT/PSS composition ratio of the local maximum value θa. In the same manner, for the laminated structure B, the light emitting efficiency local maximum value θb-composition ratio curve is obtained. Next, from these curves, the relationship between the θa×θb and the composition ratio, that is, θa×θb-composition ratio curve is obtained so as to find the maximum value ηm (a×b) in the θa×θb-composition ratio curve. For the composition ratio common to the laminated structure A and the laminated structure B, it is preferable that the composition ratio corresponding to ηm (a×b) is used. Accordingly, in one organic EL element, the composition ratio of the components forming the hole transporting layers in different laminated structures can be set in common so that an organic EL element, whose geometric mean of the light emitting efficiency in each laminated structure is maxim, can be provided.

Moreover, based on the maximum value ηm (a×b) in the θa×θb-composition ratio curve obtained in the above, the composition ratio corresponding to 0.7 ηm(a×b) to 1 ηm (a×b) can be employed for the laminated structure A and another laminated structure B of a different light emitting material. Thereby, an organic El element without drastic deterioration from the geometric mean of the light emitting efficiency in each laminated structure can be provided.

In addition thereto, as a material forming each layer of the organic EL element of the present invention, the following known materials can be used.

The glass substrate explained with reference to FIG. 1 is not limited to a glass substrate. It is a substrate which can be substituted by an inorganic transparent material such as a glass and a quartz, or a transparent synthetic resin material. The material of the substrate and its thickness can be selected optionally. The material of the substrate is selected often from the transparent materials, but it can also be selected from the non transparent materials.

The first electrode (anode) can be any one as long as it is made of a material used for an ordinary organic EL element. As needed, it may be patterned. In particular, for facilitating the injection of the hole, it is preferably a transparent or semi-transparent conductive material having a large work function. Specifically, the examples thereof include an indium tin oxide (ITO), an indium oxide, a gold, an indium zinc oxide (IZO) and the like.

As to the second electrode (cathode), it can also be any one as long as it is made of a material used for an ordinary organic El element. In particular, for facilitating the injection of the electron, it is preferably a conductive material having a small work function. Specifically, the examples thereof include a magnesium alloy (MgAg), an aluminum, a silver and the like.

In the organic EL element of the present invention, at least one insulation layer can be formed on the substrate or on the anode partially. The insulation layer is preferably made of a resin material including a photo-curing resin such as an ultraviolet ray curing resin or a thermosetting resin. It may be formed in a pattern such that portions where the insulation layer is provided will be a non-light emitting part at the time of the display. Moreover, by mixing a carbon black or the like to the resin material, the insulation layer may be formed as a black matrix.

In the example explained with reference to FIG. 1, the laminated structure with the hole transporting layer and the light emitting layer, or the hole transporting layer, the light emitting layer and the electron transporting layer laminated between the first electrode and the second electrode has been presented. However, with the light emitting layer formed of the organic light emitting material capable of generating the electroluminescence provided as an essential layer, optional layers such as: a hole transporting layer for transporting the hole into the light emitting layer; a hole injecting layer for injecting the hole to the hole transporting layer; an electron transporting layer; an electron injecting layer can be provided between the first electrode and the second electrode. These layers to be laminated between the first electrode and the second electrode are referred to as the organic EL layer, as a whole.

As the organic light emitting materials forming the light emitting layer, on the whole, a pigment based light emitting material, a metal complex based light emitting material, a polymer based light emitting material or the like can be presented.

As the pigment based light emitting material, for example, a cyclopentadiene derivative, a tetraphenyl butadiene derivative, a triphenyl amine derivative, an oxadiazol derivative, a pyrazoloquinoline derivative, a distylyl benzene derivative, a distylyl arylene derivative, a silol derivative, a thiophene ring compound, a pyridine ring compound, a perynon derivative, a perylene derivative, an oligothiophene derivative, a triphmanyl amine derivative, an oxadiazol dimer, a pyrazoline dimer or the like can be presented.

As the metal complex based light emitting material, for example, metal complexes: having an Al, a Zn, a Be, or the like, or a rare earth metal such as a Tb, an Eu, a Dy, or the like as the central metal; and having an oxadiazol, a thiadiazol, a phenylpyridine, a phenyl benzoimidazol, a quinoline structure, or the like as the ligand; such as an aluminum quinolinol complex, a benzoquinolinol beryllium complex, a benzoxazol zinc complex, a benzothiazol zinc complex, an azomethyl zinc complex, a porphiline zinc complex, an europium complex, or the like can be presented.

As the polymer based light emitting material, for example, a polyparaphenylene vinylene derivative, a polythiophene derivative, a polyparaphenylene derivative, a polysilane derivative, a polyacetylene derivative, or the like, a polyfluolenone derivative, or a polyvinyl carbazol derivative, or the like, or a polymer of the pigment based or metal complex based light emitting materials can be presented.

For the purpose of improving the light emitting efficiency, changing the light emitting wavelength, or the like, doping can be carried out to the light emitting layer comprising the organic light emitting materials. As the doping material for carrying out the doping operation, for example, a perylene derivative, a coumarin derivative, a quinacrydone derivative, a squalium derivative, a porphiline derivative, a styryl based pigment, a tetracene derivative, a pyrazoline derivative, a decacyclene, a phenoxazone, or the like can be presented.

The hole injecting layer is provided between the anode and the hole transporting layer, or between the anode and the light emitting layer. As the material forming the hole injecting layer, for example, a phenyl amine based, a star burst type amine based, or a phthalocyanine based, oxides such as a vanadium oxide, a molybdenum oxide, a ruthenium oxide and an aluminum oxide, or an amorphous carbon, a polyaniline, a polythiophene derivative, or the like can be presented.

The electron transporting layer is provided between the light emitting layer and the cathode, or between the light emitting layer and the electron injecting layer. As the material forming the electron transporting layer, for example, substances generally forming a stable radical anion, having a large ionizing potential, such as oxadiazols, the aluminum quinolinol complex, or the like can be presented. Specifically, the examples thereof include a 1,3,4-oxadiazol derivative, a 1,2,4-triazolderivative, or the like can be presented.

The electron injecting layer is provided between the electron transporting layer and the cathode, or between the cathode and the light emitting layer. As the material forming the electron injecting layer, 1A group or 2A group metals, oxides thereof or halides thereof can be presented. As the examples of the 1A group metals, the oxides thereof and the halides thereof, specifically, a lithium fluoride, a sodium oxide, a lithium oxide, or the like can be presented. As the examples of the 2A group metals, the oxides thereof and the halides thereof, specifically, a strontium, a magnesium oxide, a magnesium fluoride, a strontium fluoride, a calcium, a calcium fluoride, a barium fluoride, a strontium oxide, or the like can be presented.

### EXAMPLE 1

A required number of anode substrates were obtained by: using a cleaned glass plate (produced by Coning Inc., product No. 1737) as a substrate; forming an ITO thin film on the surface so as the thickness thereof is 1,500 Å; forming an anode by etching the formed ITO thin film in a predetermined pattern; and then cutting. After cleaning the anode surface of the obtained anode substrates, the PEDOT/PSS dispersion solutions of four kinds of the following compositions (1) to (4) were coated by spin coating on the anode surface with the composition changed for each anode substrate. After the coating operation, they were placed on a 200° C. temperature hot plate so as to be heated for 30 minutes and dried. Furthermore, they were moved into a pure nitrogen substituted globe box so as to be placed again on a 200° C. temperature hot plate and heated for 15 minutes for drying. Thereby, four kinds of PEDOT/PSS thin films with different composition ratios were formed on the anode. As to the following (4), the thin film thickness was 100 nm, and for the others, the thickness of the thin film was 80 nm each.
(1) PEDOT/PSS=1/6 (produced by Bayer AG, Baytron P VP AI4083 was used.)
(2) PEDOT/PSS=1/10 (produced by mixing (1) and (2).)
(3) PEDOT/PSS=1/16 (produced by mixing (1) and (2).)
(4) PEDOT/PSS=1/20 (produced by Bayer AG, Baytron P VP CH8000 was used.)

A light emitting layer forming solution was prepared by mixing a fluorescent substance for the organic EL element (produced by Sigma Aldrich Corp., product no. ADS228GE) in a toluene, so as to be 1.0% (mass ratio) concentration. The solution was coated on the PEDOT/PSS thin film obtained as mentioned above by spin coating in the globe box. After the coating operation, it was placed on a 130° C. temperature hot plate so as to be heated for one hour for drying so that a 80 nm thickness light emitting layer was formed.

Onto the light emitting layer on the substrate with the layers up to the light emitting layer formed thereon, deposition was carried out in the globe box so as to form a 3 nm thickness LiF thin film and a 10 nm thickness Ca thin film in sequence to provide an electron injecting layer. Furthermore, a 180 nm thickness Al thin film was formed on the electron injecting layer to provide a cathode.

Thereafter, an ultraviolet ray curing type adhesive (produced by Nagase ChemeteX Corporation, product no. XNR5516HP-B1) was applied to projecting parts of a glass for sealing having projecting parts on the periphery. The glass superimposed on the substrate with the cathode formed thereon. By irradiating an ultraviolet ray to the part where the adhesive is applied, the adhesive was cured. The superimposed substrates after the ultraviolet ray irradiation were placed on a 80° C. temperature hot plate so as to be heated for one our for sufficiently curing the adhesive so that an organic EL element was obtained.

For the organic EL elements comprising the hole transporting layers accordingly formed with the 1/20, 1/16, 1/10 and 1/6 PEDOT/PSS composition ratios, the current-voltage curve and the brightness-voltage curve were measured. The measurement results were already explained in the description of “Description of the preferred embodiments”.

Moreover, for the obtained organic EL elements, voltage was applied continuously so as to obtain 200 Cd initial brightness. The brightness change with time passage was measured. The results of the time for the brightness to be dropped by half, that is, the time until the brightness is reduced to be an half of the initial brightness, are shown in the table 1, together with each light emitting efficiency. In consideration to the time for the brightness to be dropped by half and the light emitting efficiency, the PEDOT/PSS composition ratio is preferably 1/20 to 1/10. The 1/6 PEDOT/PSS composition ratio is not preferable in terms of the time for the brightness to be dropped by half and the light emitting efficiency. The light emitting efficiency maximum value in the local maximum value-composition ratio curve of FIG. 5 substantially corresponds to the 1/16 composition ratio, and the PEDOT/PSS composition ratio which has a value as 0.7 times as the maximum value is substantially 1/7.

TABLE 1

| PEDOT/PSS | Time for the brightness to | Light emitting |
|---|---|---|
| composition ratio | be dropped by half (hour) | efficiency (cd/A) |
| 1/20 | 2000 | 14 |
| 1/16 | 2000 | 16 |
| 1/10 | 2000 | 13 |
| 1/6 | 1000 | 10 |

1. An organic EL element having a laminated structure of at least: a first electrode; a hole transporting layer; a light emitting layer; and a second electrode laminated in sequence,
wherein the hole transporting layer comprises components of: a poly(ethylene dioxythiophene); and a polystyrene sulfonic acid,
a composition ratio of the components is: poly(ethylene dioxythiophene)/the polystyrene sulfonic acid=1/20 to 1/6, and
the composition ratio of the components corresponds to a light emitting efficiency maximum value ηm in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

2. An organic EL element having a laminated structure of at least: a first electrode; a hole transporting layer; a light emitting layer; and a second electrode laminated in sequence,
wherein the hole transporting layer comprises components of: a poly(ethylene dioxythiophene); and a polystyrene sulfonic acid,
a composition ratio of the components is: poly(ethylene dioxythiophene)/the polystyrene sulfonic acid=1/20 to 1/6, and
the composition ratio of the components corresponds to 0.7 ηm to ηm, when ηm is a light emitting efficiency maximum value in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

3. An organic EL element having a laminated structure of at least: a first electrode; a hole transporting layer; a light emitting layer; a electron transporting layer; and a second electrode laminated in sequence,
wherein the hole transporting layer comprises components of: a poly(ethylene dioxythiophene); and a polystyrene sulfonic acid,
a composition ratio of the components is: poly(ethylene dioxythiophene)/the polystyrene sulfonic acid=1/20 to 1/6, and
the composition ratio of the components corresponds to 0.7 ηm to ηm, when nm is a light emitting efficiency maximum value in a light emitting efficiency local maximum value θ-composition ratio curve, which is obtained by changing the composition ratio of the light emitting efficiency local maximum value θ (θ is a light emitting efficiency local maximum value in a light emitting efficiency-voltage curve, which is obtained by changing an applied voltage between the first electrode and the second electrode in the laminated structure).

4. The organic EL element according to claim 1, wherein the organic EL element comprises two or more kinds of the laminated structures whose light emitting layers comprise different light emitting materials.

5. The organic EL element according to claim 2, wherein the organic EL element comprises two or more kinds of the laminated structures whose light emitting layers comprise different light emitting materials.

6. The organic EL element according to claim 3, wherein the organic EL element comprises two or more kinds of the laminated structures whose light emitting layers comprise different light emitting materials.

7. The organic EL element, wherein the light emitting material forming the light emitting layer, of each laminated structure of the organic EL element described in claim 4, is different from each other, and
the composition ratios of the components forming the hole transporting layer in each of at least two laminated structures “a” and “b”, among the laminated structures, are a common composition ratio corresponding to an overlapped portion of both ranges of 0.7 ηma to ηma and 0.7 ηmb to ηmb, when ηma is the light emitting efficiency maximum value in a light emitting efficiency local maximum value θa-composition ratio curve, and ηmb is the light emitting efficiency maximum value in a light emitting efficiency local maximum value θb-composition ratio curve, which are obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

8. The organic EL element, wherein the light emitting material forming the light emitting layer, of each laminated structure of the organic EL element described in claim 5, is different from each other, and
the composition ratios of the components forming the hole transporting layer in each of at least two laminated structures “a” and “b”, among the laminated structures, are a common composition ratio corresponding to an overlapped portion of both ranges of 0.7 ηma to ηma and 0.7 ηmb to ηmb, when ηma is the light emitting efficiency maximum value in a light emitting efficiency local maximum value θa-composition ratio curve, and ηmb is the light emitting efficiency maximum value in a light emitting efficiency local maximum value θb-composition ratio curve, which are obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

9. The organic EL element, wherein the light emitting material forming the light emitting layer, of each laminated structure of the organic EL element described in claim 6, is different from each other, and
the composition ratios of the components forming the hole transporting layer in each of at least two laminated structures “a” and “b”, among the laminated structures, are a common composition ratio corresponding to an overlapped portion of both ranges of 0.7 ηma to ηma and 0.7 ηmb to ηmb, when ηma is the light emitting efficiency maximum value in a light emitting efficiency local maximum value θa-composition ratio curve, and ηmb is the light emitting efficiency maximum value in a light emitting efficiency local maximum value θb-composition ratio curve, which are obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

10. The organic EL element, wherein the light emitting material forming the light emitting layer, of each laminated structure of the organic EL element described in claim 4, is different from each other, and
the composition ratios of the components forming the hole transporting layer in each of at least two laminated structures “a” and “b”, among the laminated structures, are a common composition ratio corresponding to light emitting efficiency maximum value rim (a×b) in a×b-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

11. The organic EL element, wherein the light emitting material forming the light emitting layer, of each laminated structure of the organic EL element described in claim 5, is different from each other, and
the composition ratios of the components forming the hole transporting layer in each of at least two laminated structures “a” and “b”, among the laminated structures, are a common composition ratio corresponding to light emitting efficiency maximum value ηm (a×b) in a×b-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

12. The organic EL element, wherein the light emitting material forming the light emitting layer, of each laminated structure of the organic EL element described in claim 6, is different from each other, and
the composition ratios of the components forming the hole transporting layer in each of at least two laminated structures “a” and “b”, among the laminated structures, are a common composition ratio corresponding to light emitting efficiency maximum value ηm (a×b) in a×b-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

13. The organic EL element, wherein the light emitting material forming the light emitting layer, of each laminated structure of the organic EL element described in claim 4, is different from each other, and
the composition ratios of the components forming the hole transporting layer in each of at least two laminated structures “a” and “b”, among the laminated structures, are composition ratios corresponding to 0.7 ηm (a×b) to ηm (a×b), when ηm (a×b) is a light emitting efficiency maximum value in θa×θb-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

14. The organic EL element, wherein the light emitting material forming the light emitting layer, of each laminated structure of the organic EL element described in claim 5, is different from each other, and
the composition ratios of the components forming the hole transporting layer in each of at least two laminated structures “a” and “b”, among the laminated structures, are composition ratios corresponding to 0.7 ηm (a×b) to ηm (a×b), when ηm (a×b) is a light emitting efficiency maximum value in θa×θb-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).

15. The organic EL element, wherein the light emitting material forming the light emitting layer, of each laminated structure of the organic EL element described in claim 6, is different from each other, and
the composition ratios of the components forming the hole transporting layer in each of at least two laminated structures “a” and “b”, among the laminated structures, are composition ratios corresponding to 0.7 ηm (a×b) to ηm (a×b), when ηm (a×b) is a light emitting efficiency maximum value in θa×θb-composition ratio curve, which is obtained by changing the composition ratio of each light emitting efficiency local maximum value θa and θb (θa and θb are light emitting efficiency local maximum values in each light emitting efficiency-voltage curve, which is obtained by changing the applied voltage between the first electrode and the second electrode in each laminated structure).
